(19) United States
(12) Patent Application Publication
(10) Pub. No.: US 2020/0195421 A1
(43) Pub. Date: Jun. 18, 2020

(54) MINING FOR INTERNET ACCESS

(71) Applicant: Hewlett Packard Enterprise Development LP, Houston, TX (US)

(72) Inventor: JEAN-FRANCOIS GAGNON, Quebec (CA)

(21) Appl. No.: 16/218,358

(22) Filed: Dec. 12, 2018

(51) Int. Cl. H04L 9/06; H04W 48/14; H04L 29/06; H04L 9/32

(52) U.S. Cl. CPC H04L 9/0637; H04W 48/14; H04W 84/12; H04L 9/3236; H04L 2209/38; H04L 63/10

(57) ABSTRACT

The disclosure describes techniques for providing network access to a user device in exchange for performing a blockchain mining task. The blockchain mining task may be based on any suitable blockchain consensus protocol for verifying one or more blockchain transactions that are written to a block of a blockchain, and it may utilize a processing and/or memory resource of the user device. In some implementations, a method includes: a user device transmitting a request for a blockchain mining task; in response to transmitting the request, receiving the blockchain mining task from an access point; performing the blockchain mining task by using a processing resource or memory resource of the user device; and accessing a computer network through the access point using data awarded in response to performing the blockchain mining task.

### DESCRIPTION OF THE RELATED ART

A “distributed ledger” generally refers to a shared digital ledger that is decentralized and shared between nodes distributed across a network. After a transaction that is approved to be written to the ledger is consented by at least the majority of the nodes, the contents of the ledger are synchronized across all the nodes. One presently popular type of distributed ledger technology is blockchain technology. While in a distributed ledger a transaction is written to the ledger after consensus, the requirement is more specific in a blockchain: transactions are aggregated in to a block and the block is appended to the last block of an existing linear chain of blocks. Blockchain technology is presently popular in the use of cryptocurrencies and development of decentralized applications. BITCOIN and ETHEREUM are examples of blockchain-based platforms.

Different types of consensus mechanisms such as proof of work and proof of stake that bring in varying levels of processing requirements to agree on a transaction amongst distributed nodes may be utilized in a blockchain network. A common technique used in such consensus mechanisms is a process referred to as “mining” by which new transactions are validated and recorded in a block using a computational resource. For example, in the case of proof work, miners compete for a reward to be the first to solve a computationally expensive mathematical problem based on a cryptographic hash algorithm that may increase in complexity as the blockchain grows. The solution may be referred to as a “proof of work,” signifying that the miner spent substantial computational resources solving the problem. The term “mining” derives from the fact that the proof of work is solved by repeated trial and error, referred to as “hammering away” at the problem until a solution is found. After a solution is found, the blockchain transactions may be considered confirmed and a new block may be added to the blockchain network.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments.

FIG. 1 is a diagram illustrating an example environment in which an access point is used to provide Internet access to a user device in exchange for blockchain mining, in accordance with implementations of the disclosure.

FIG. 2 illustrates an example blockchain, in accordance with implementations of the disclosure.

FIG. 3 is a block diagram illustrating an example architecture of components of a user device, in accordance with implementations of the disclosure.

FIG. 4 is a block diagram illustrating an example architecture of components of an access point, in accordance with implementations of the disclosure.

FIG. 5 is an operational flow diagram illustrating an example method of a mobile user device connecting to wireless access point to receive internet access in exchange for blockchain mining, in accordance with implementations of the disclosure.

FIG. 6 is an operational flow diagram illustrating another example method of a mobile user device connecting to wireless access point to receive internet access in exchange for blockchain mining, in accordance with implementations of the disclosure.

FIG. 7 is an operational flow diagram illustrating an example method that may be implemented by a user device connected to an access point to receive network access from the access point in exchange for blockchain mining, in accordance with implementations of the disclosure.

FIG. 8 is an operational flow diagram illustrating an example method that may be implemented by a wireless network access system using an AP to connect to a user device and provide network access in exchange for blockchain mining, in accordance with implementations of the disclosure.

FIG. 9 is a sequence diagram illustrating a particular example method that may be implemented in the environment of FIG. 1 for providing Internet access to a user device in exchange for blockchain mining, in accordance with implementations of the disclosure.

FIG. 10 is a sequence diagram illustrating a particular example method that may be implemented in the environment of FIG. 1 for providing Internet access to a user device in exchange for blockchain mining, in accordance with implementations of the disclosure.

The figures are not intended to be exhaustive or to limit various embodiments to the precise form disclosed.

### DETAILED DESCRIPTION

As used herein, the term “blockchain mining” refers to using one or more of a processing resource or memory resource of a device as part of a blockchain consensus protocol in an attempt to verify one or more blockchain transactions that are written to a block of a blockchain. For example, blockchain mining may use a processor and/or memory of a user device as part of a proof-of-work, proof-of-space, proof-of-time, proof-of-stake, or some other blockchain consensus protocol. In some specific implementations, blockchain mining may refer to using computational resources of a user device to compute one or more cryptographic hashes as part of a consensus protocol such as proof of work.

As used herein, the terms “hashing,” “computing a hash,” and like terms or phrases refer to taking a byte array and applying a cryptographic hashing function to the byte array to transform that byte array to non-predictable deterministic fixed-size bytes.

Various implementations of the disclosure are directed to providing network access to a user device through an access point in exchange for blockchain mining. Some particular implementations are directed to installing an application on the user device for providing Internet access in exchange for blockchain mining. Other particular implementations are directed to utilizing the user device's OS to obtain Internet access in exchange for blockchain mining. As will be appreciated by the forthcoming discussion, various technical advantages may be achieved by virtue of the implementations described herein. For example, the technology disclosed herein may be used to utilize underused processors and/or memory devices of a user device to obtain free Internet access while providing an AP provider with the benefit of blockchain mining (e.g., cryptocurrency rewards, transaction rewards, or some other reward for mining a block). Further, in implementations where a consensus protocol that requires hashing is used, the technology disclosed herein may provide the flexibility to hash any type of blockchain and to adjust a hashing rate.

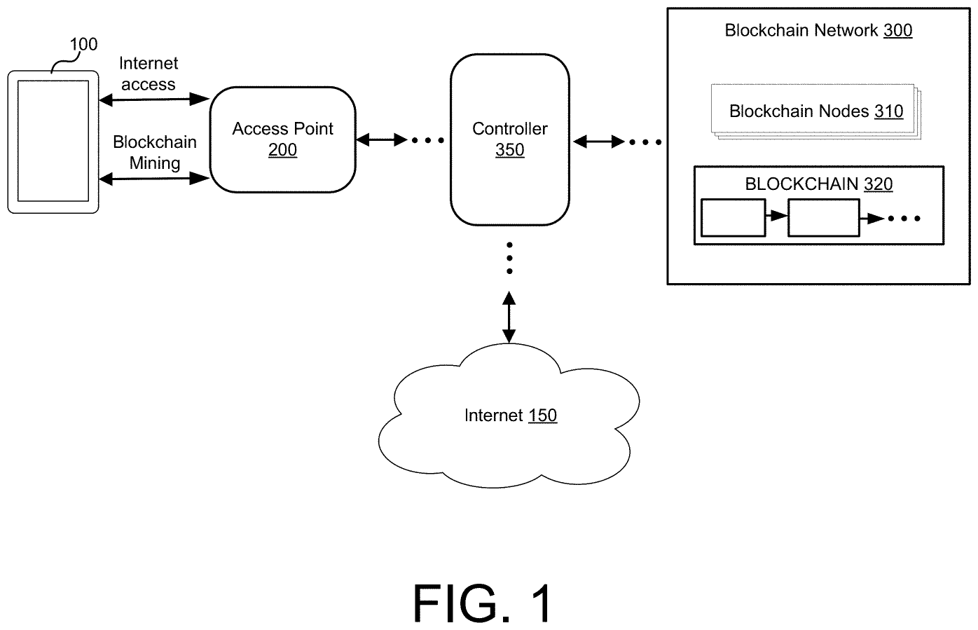

FIG. 1 is a diagram illustrating an example environment in which an access point (AP) 200 is used to provide Internet access to a user device 100 in exchange for blockchain mining, in accordance with implementations of the disclosure. In the example environment of FIG. 1, user device 100 is configured to scan for and connect to APs that provide access to the Internet 150. More particularly, user device 100 connects to an AP 200 that provides access to Internet 150 in exchange for performing a blockchain mining task. For example, user device 100 may be a smartphone or other user device that scans for and connect to wireless APs (e.g., WIFI APs that provide Internet access through at least a WIFI connection in exchange for blockchain mining) in locations outside of a user's home such as a hotel, an airport, a café, a retail store, in an airplane, etc. Implementations of the disclosure will be primarily described in this context. However, it should be appreciated that in alternative implementations user device 100 may be connect to an AP 200 in the user's home that is provided by an internet service provider as part of an internet service plan. For example, AP 200 may be a home router enabled to provide Internet access in exchange for blockchain mining. Moreover, although implementations described herein will be described primarily in the context of wireless APs, in some instances (e.g., for home networks) the user device 100 may connect to AP 200 using a wired connection (e.g., via Ethernet).

It should be appreciated that although a single user device 100 and AP 200 are shown in this environment, multiple user devices 100 may connect to an AP 200 to access the Internet 150 in exchange for blockchain mining. Additionally, multiple APs may be present in this environment, in which case some or all of the APs may provide Internet access in exchange for blockchain mining. Furthermore, although a single blockchain network 300 containing a copy of a blockchain 320 that is propagated to blockchain nodes 310 is illustrated in this example, in some implementations an AP 200 may be capable of assigning a user device 100 a blockchain mining task for a plurality of different blockchains. For instance, an AP 200 may be capable of assigning a user device 100 to mine for one of a plurality of cryptocurrencies such as ether and bitcoin. Moreover, it should be appreciated that although implementations of the disclosure will be primarily described in the context of providing Internet access in exchange for blockchain mining, implementations described herein may more generally apply to providing access to any network in exchange for blockchain mining. For example, access to a content delivery network (e.g., to view television series or movies), an intranet, a local area network, or any other suitable network may be provided in exchange for blockchain mining.

As illustrated in FIG. 1, user device 100 may be a mobile device such as a smartphone, tablet, or notebook computer. In some implementations, client device may be implemented as a wearable device such as a smartwatch. In further implementations, client device may be implemented as a gaming device, a desktop computer, or any other type of device that may be configured to perform a blockchain mining task in exchange for access to a network (e.g., Internet 150). As further described below, the blockchain mining task performed by user device 100 includes using a processing resource or memory resource of a user device as part of a blockchain consensus protocol for verifying one or more blockchain transactions that are written to a block of a blockchain. In specific implementations, such as implementations based on a proof-of-work consensus protocol, the blockchain mining task includes the computation of hashes to verify transactions for a blockchain 320 present on a blockchain network 300.

AP 200 may refer to hardware networking device that allows one or more user devices 100 to gain access to a network (e.g., Internet 150). For example, AP 200 may be implemented as an IEEE 802.11 AP that connects a WIFI device to a wired network such as a wired LAN. In the example of FIG. 1, AP 200 communicatively couples to a wireless LAN (WLAN) controller 350 that may connect to multiple APs. In other implementations, AP 200 may be integrated into a wireless LAN (WLAN) controller. In some implementations, AP 200 may be a controllerless AP. In some implementations, AP 200 may run virtualized controller software. Implementations described herein will be primarily described in the context of wireless APs that provide network access to user device 100 through a WIFI connection. In alternative implementations, user device 100 may connect to AP 200 using some other wired or wireless communication protocol such as BLUETOOTH, ZIGBEE, free space optical communications, etc. In some implementations, APs 200 may allow user devices to wirelessly connect using a plurality of different communication protocols such as WIFI, BLUETOOTH, ZIGBEE, and the like.

As noted above, in the environment of FIG. 1 AP 200 and/or controller 350 are configured to provide Internet access in exchange for blockchain mining. Particularly, AP 200 and/or controller 350 may be configured to assign blockchain mining tasks to user devices 100 based on the blockchain 320 distributed by blockchain nodes 310 and unverified blockchain transactions of blockchain network 300. As further described below, in some implementations a blockchain mining task may identify what value(s) is/are to be hashed, the hashing algorithm that is to be used, and a hash rate.

Blockchain network 300 may be any blockchain network that implements mining as part of its consensus mechanism (e.g., as part of a proof of work, proof of space, proof of stake, etc.) for verifying blockchain transactions that are added to blockchain 320. In some implementations, the blockchain 320 of blockchain network 300 may provide a record of transactions involving cryptocurrencies. In other implementations, the blockchain 320 may provide a record of other types of transactions. Blockchain network 300 may include a plurality of blockchain nodes 310 that may validate transactions. Some or all blockchain nodes 310 may store a respective copy of a blockchain 320 that contains a chronologically ordered, back-linked list of blocks.

In the example of FIG. 1, controller 350 may be configured to communicate with blockchain network 300 to determine the appropriate mining task that is to be assigned by AP 200 to user device 100. For example, controller 350 may compile all of the information of a block to be added to the blockchain into a value that is used for hashing by user devices 100. Although controller 350 is illustrated in this example as being outside of blockchain network 300, in some implementations controller 350 may function as a blockchain node 310 on blockchain network 300 that verifies transactions. In other implementations, controller 350 may indirectly obtain the value that is to be hashed (e.g. from a blockchain node 320). In some implementations, a plurality of user devices 100 connected to one or more APs 200 may form a blockchain mining pool. For example, mining tasks may be assigned to the various user devices 100 such that they hash different values during mining for a proof of work. In some instances, controller 350 may direct the blockchain mining tasks that are assigned by APs 200 to user devices 100.

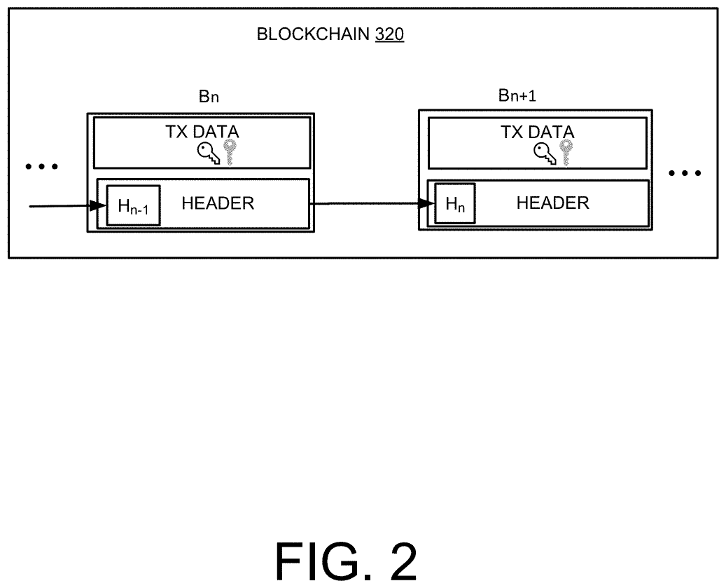

FIG. 2 illustrates an example data structure of a blockchain 320, in accordance with implementations of the disclosure. As illustrated, the data structure of blockchain 320 is a sequentially ordered, back-linked list of blocks, including transactions made by blockchain nodes. In this implementation, each block of the blockchain comprises a header and transaction information related to one or multiple transactions conducted on the blockchain network. The header of each block (except for the first block, e.g., the genesis block) may include the hash of the previous block header and hash of the transaction tree root (merkle root hash). In implementations, the header may comprise additional block metadata such as a timestamp (e.g., the approximate creation time of the block), hash trees (e.g., for transaction information, state information, etc.) and other information.

To illustrate one particular example of blockchain mining, consider the case where blockchain 320 corresponds to the BITCOIN blockchain. In this example, transactions may be collected from a transaction pool to build a candidate block. A Merkle Root hash may be calculated for all of the transactions. Thereafter, a block header may be created by combining the current blockchain version, the previous block's hash, the Merkle Root hash, the current time, difficulty bits (current difficulty level), and a nonce. In this context, the nonce may refer to a placeholder for a random number to be tried in order to create a new hash from the same candidate block. A blockchain mining hash may be calculated by applying a SHA-256 hashing algorithm twice to the block header. If the mining hash has a certain number of leading zeros (e.g., depending on difficulty level), the hash may be considered successful. Otherwise, the above process may repeat using a new nonce. Once a nonce in the candidate block makes a hash with enough leading zeros (i.e., a winning block is found), the block may be sent to all participating nodes for consensus, and the node may be rewarded for adding the block.

It should be emphasized that although the above example illustrates the operation of blockchain mining in the context of BITCOIN, implementations described herein may be used with any blockchain protocol that uses a mining consensus mechanism that relies on processing and/or memory resources of a device to verify one or more blockchain transactions that are written to a blockchain. For example, in implementations where the blockchain uses a proof-of-space consensus protocol, blockchain may comprises the user device allocating memory or disk space to solve a challenge. As such, the implementations described herein need not be limited to blockchain mining that relies on computational power to compute hashes.

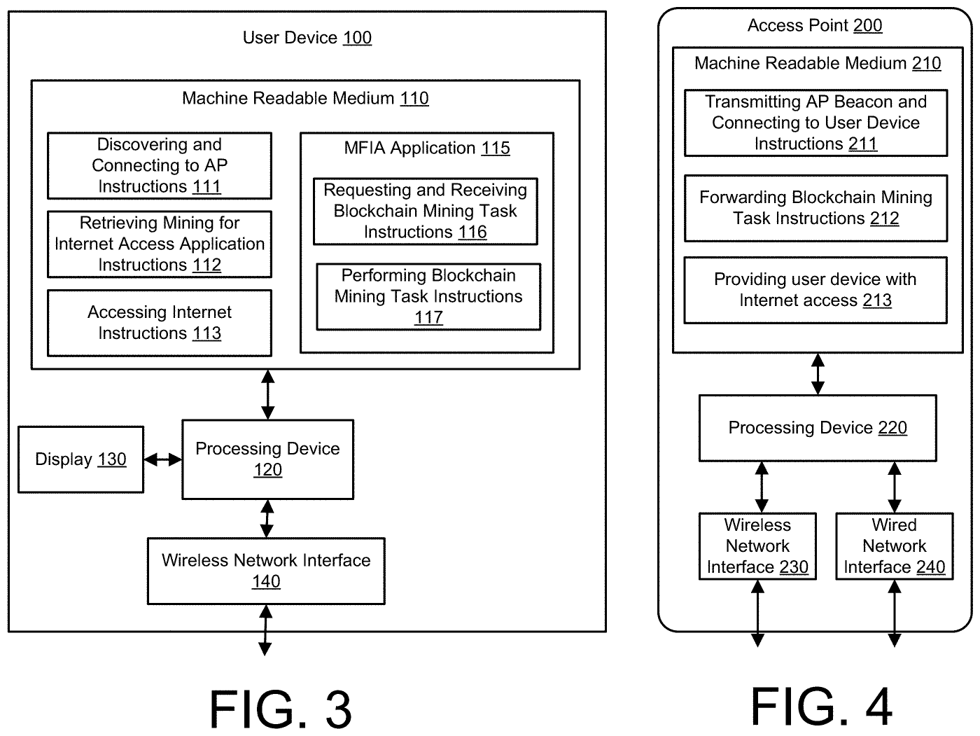

FIG. 3 is a block diagram illustrating an example architecture of components of a user device 100, in accordance with implementations of the disclosure. A user device 100 may include a machine readable medium 110, a processing device 120, a display 130, and a wireless network interface 140. Wireless network interface 140 may be to communicate with APs 200. It may include a receiver to receive communications from an AP 200 and a transmitter to transmit communications to an AP 200. For example, the receiver may be to receive beacons broadcast by AP 200, receive data retrieved from the Internet, receive data related to blockchain mining and/or a data balance, etc. The transmitter may be transmit data to a node on the Internet through AP 200, to initialize a connection to AP 200, to transmit data related to blockchain mining, etc. In some implementations, the receiver and transmitter may be implemented as a transceiver, such as a WIFI, BLUETOOTH, or ZIGBEE transceiver.

Machine readable medium 110 may store various instructions that may be executed by processing device 120 to implement various embodiments in accordance with the disclosure. For example, machine readable medium 110 may store instructions 111 for discovering and connecting to APs, instructions 112 for retrieving an application (e.g., MFIA application 115) that enables mining for Internet access (MFIA), and instructions 113 for accessing Internet content. Machine readable medium 110 may also store an MFIA application 115 that may be retrieved from an App store and run by user device 100 to perform blockchain mining tasks for an AP 200 in exchange for Internet access. MFIA application 115 may include instructions 116 for requesting and receiving a blockchain mining task, and instructions 117 for performing a blockchain mining task. In alternative implementations, instructions 116-117 may be natively incorporated into the operating system (OS) of the device.

Display 130 may be to display wireless APs that are available to connect to, to display data retrieved over the Internet, to display data relating to blockchain mining (e.g., through an application 115), and to display other data.

FIG. 4 is a block diagram illustrating an example architecture of components of an AP 200, in accordance with implementations of the disclosure. An AP 200 may include a machine readable medium 210, a processing device 220, a wireless network interface 230, and a wired network interface 240. Wireless network interface 230 may be to transmit and/or receive communications (e.g., communications related to blockchain mining and/or Internet access) to/from one or more user devices 100. In implementations, wireless network interface 230 may be a WIFI interface. Wired network interface 240 may be to connect AP 200 (and connected user devices 100) to a wired network such as a wired LAN. For example, wired network interface 240 may be to connect AP 200 to a controller 350 using an Ethernet connection.

Machine readable medium 210 may store various instructions that may be executed by processing device 220 to implement various embodiments in accordance with the disclosure. For example, machine readable medium 210 may store instructions 211 for transmitting a beacon and connecting to user devices 100, instructions 212 for forwarding a blockchain mining task for a user device 100, and instructions 213 for providing a user device 100 with Internet access. In some implementations, the AP 200 may also include instructions for creating the blockchain mining task. Alternatively, the instructions for creating the blockchain mining task may reside in a controller 350 separate from AP 200, and in such implementations the AP 200 may function to forward the mining task created by the controller 350. More generally, it should be appreciated that the tasks described herein as being performed by AP 200 may be performed by controller 350 or some other device.

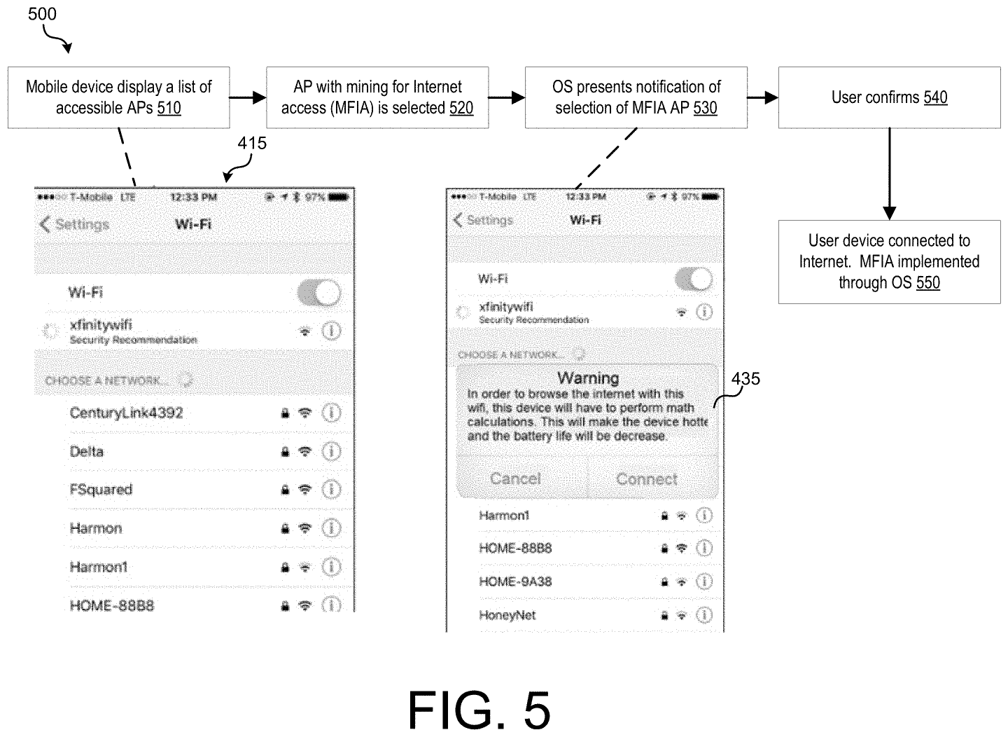

FIG. 5 is an operational flow diagram illustrating an example user interface method 500 of a mobile user device (e.g., user device 100) connecting to wireless AP (e.g., AP 200) to receive Internet access in exchange for blockchain mining, in accordance with implementations of the disclosure. In some implementations, some or all of the operations of method 500 may be implemented by a processing device 120 executing one or more of instructions 111, 113, 116, and 117. In this example implementation, the user device OS may support mining for Internet access (e.g., no external App 115 needed).

At operation 510, the mobile device displays a list of accessible APs 510. For instance, as illustrated by the particular example of GUI 415, a list of various accessible wireless APs may be displayed. In some instances, the APs that provide MFIA may have some type of indicator or icon that identify them as having this feature in the list of accessible wireless APs that is displayed.

At operation 520, an AP having a MFIA feature is selected by the user. For example, the user may tap the touchscreen of the user device to select one of the listed wireless APs. At operation 530, in response to the user selecting an AP having an MFIA feature, the OS of the user device 100 presents a notification of the selection of an AP that provides MFIA. For instance, continuing the previous example of GUI 415, a warning 435 may be displayed to the user that in order to browse the Internet with the selected AP, the user device 100 will having to perform calculations that use up battery life and/or cause the device to run hotter. Warning 435 just provides one example of the types of notifications that may be displayed to the user in response to selecting an AP with MFIA. As would be appreciated, by virtue of displaying the advance warning to the user, the process flow ensures that the user's participation in blockchain mining is voluntary. At operation 540, the user provides confirmation that the user wishes to proceed with the connection.

Following confirmation, at operation 550 the user device may connect to the Internet by implementing MFIA through the OS of the user device. Information, settings, and warnings related to MFIA may be implemented through the OS in various ways. Particular example implementations of operation 550 are further described below.

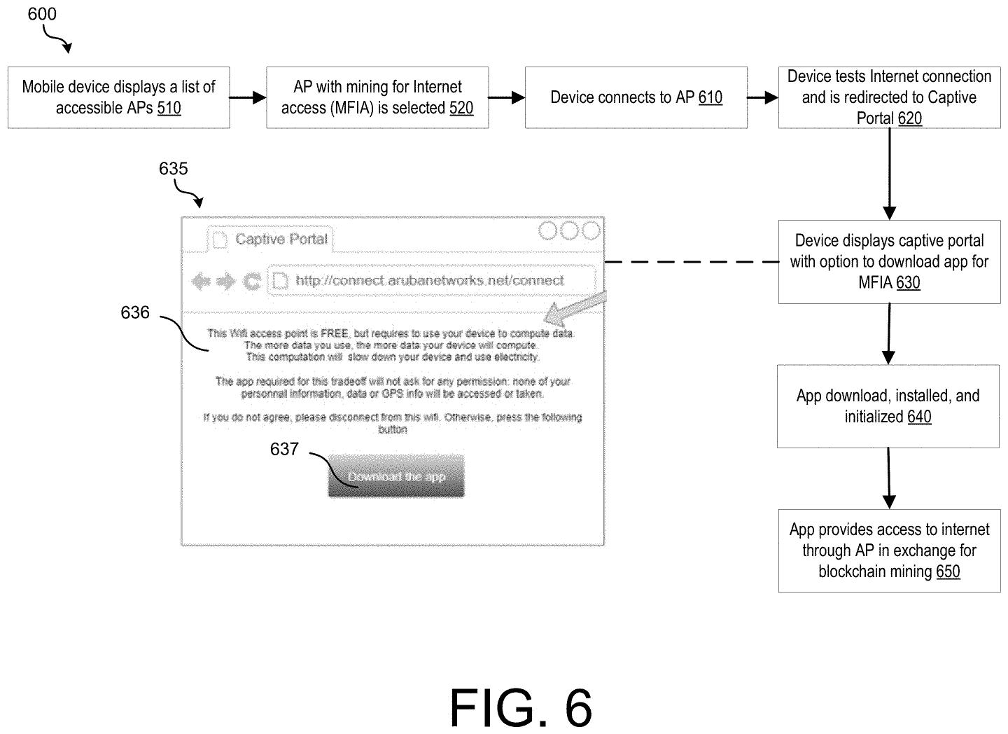

FIG. 6 is an operational flow diagram illustrating another example user interface method 600 of a mobile user device (e.g., user device 100) connecting to wireless AP (e.g., AP 200) to receive Internet access in exchange for blockchain mining, in accordance with implementations of the disclosure. In some implementations, some or all of the operations of method 600 may be implemented by a user device 100 executing one or more of instructions 111, 112, and 113, and by running MFIA application 115. In this example implementation, the user device OS may not support mining for Internet access (e.g., external App 115 is used to support blockchain mining).

Operations 510-520 of method 600 may be implemented in the same manner as described above with reference to method 500. At operation 610, the user device connects to the AP. For example, the user device may transmit an association request to the wireless AP and receive back an association response from the wireless AP. At operation 620, after connecting to the wireless AP, the user device may test its Internet connection (e.g., by attempting to access a web domain) and be redirected to a captive portal of the AP. A captive portal may refer to a web page that is displayed on a newly connected user device before users of the device are granted access to network resources (e.g., to the Internet) through the AP.

At operation 630, the user device displays the captive portal that it was redirected to, where the displayed captive portal includes an option to download an application for MFIA. For instance, as shown by the particular example of captive portal webpage 635, the captive portal may display a notification 636 that WIFI access will impact device speed and/or battery because the device is being used to compute data (e.g., compute hashes for mining), store data, or use some type of processing or memory resource. Additionally, example captive portal webpage 635 displays a control 637 that may be selected (e.g., through a touch user interface gesture) to download an application for blockchain mining in exchange for Internet access. For example, selecting control 637 may redirect the user device to download an MFIA application 115 through an appstore. For instance, depending on the OS of the user's device. As another example, control 637 or some other part of webpage 635 may include a direct software download link for the application that can be accessed by user device 120.

At operation 640, after user selection of the control for downloading the MFIA application (e.g., control 637), the application may be downloaded, installed, and initialized. The AP may permit the user device to access the appstore in order to download the application. At operation 650, following initialization of the application, the user device may connect to the Internet by implementing MFIA through the application. Information, settings, and warnings related to MFIA may be implemented through the application in various ways. Particular example implementations of operation 650 are further described below.

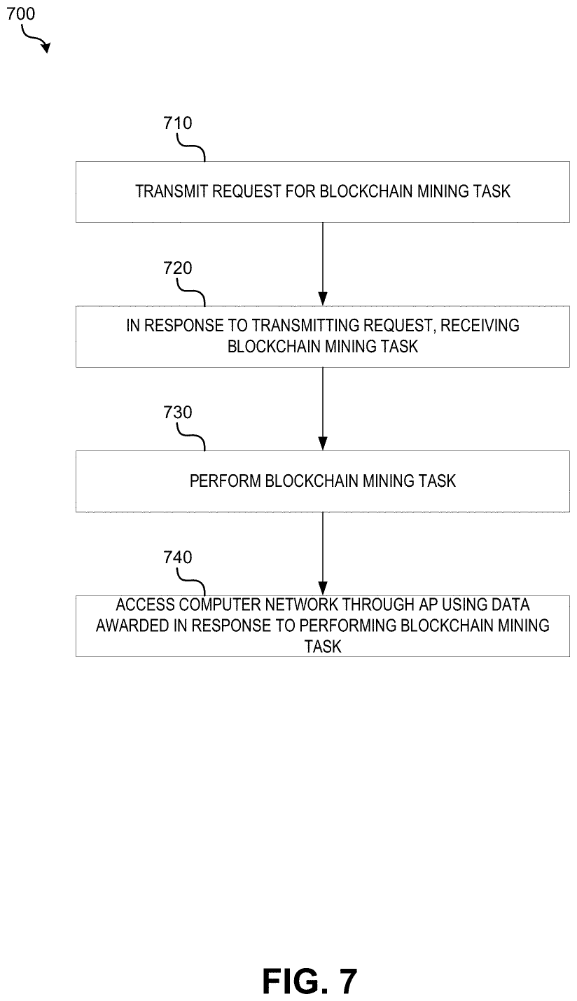

FIG. 7 is an operational flow diagram illustrating an example method 700 that may be implemented by a user device (e.g., user device 100) connected to an AP (e.g., AP 200) to receive network access (e.g., Internet access) from the AP in exchange for blockchain mining, in accordance with implementations of the disclosure. Depending on whether the user device's OS natively supports MFIA, method 700 may be performed after method 500 or 600. In some implementations, some or all of the operations of method 700 may be implemented by a processing device 120 executing one or more of instructions 113 and 116-117. In instances where the OS of user device 100 does not natively support MFIA, instructions 116-117 may be implemented by first downloading an application as described above with reference to method 600. It should be appreciated that method 700 may be iteratively repeated over time by the user device 100 to perform blockchain mining to acquire a data balance for network access and to consume the obtained data balance as it accesses the network.

At operation 710, the user device 100 transmits a request to a networked device (e.g., AP 200 or controller 350) for a blockchain mining task. The blockchain mining task may specify the utilization of the user's device processor and/or storage device based on a blockchain consensus protocol to verify one or more blockchain transactions that are written to a blockchain. For instance, in specific implementations the blockchain mining task includes one or more values to hash and a hashing technique to use. In various implementations, prior to requesting the blockchain mining task, the user device 100 may first query the AP 200 or controller 350 to determine a balance of data (e.g., in bytes) available to access the computer network. If the balance of data falls below a predetermined threshold (e.g., a value indicating that interruption of service is imminent), the user device 100 may make the request for a mining task. As such, the user device 100 may be configured to periodically poll the AP 200 or controller 350 for a data balance (e.g., in bytes) to determine when additional blockchain mining is needed to sustain the connection to the network. As part of the periodic poll, the user device may also request the hash rate per bytes.

At operation 720, in response to transmitting the request, the user device 100 receives a blockchain mining task. In various implementations, the received blockchain mining task may include one or more values to hash and a hashing technique to be used. For instance, in particular implementations the blockchain mining task may identify a value along with a range of nonces to append to the value and hash. The hashing technique may depend on the blockchain protocol. For example, SHA-256 hashing (e.g., in the case of BITCOIN), Keccak hashing (e.g., in the case of ETHEREUM), or some other hashing technique may be used depending on the blockchain protocol.

At operation 730, the user device may perform the blockchain mining task. For example, the user device may compute the hash of one or more values using an appropriate hashing technique (e.g., as identified by the AP 200 and/or controller 350). As the user device computes hashes, it may periodically send all or a subset of the computed hashes to the AP to verify that the user device is performing the mining task (in this e.g., hashing). For example, the computing device may send all hashes, a lowest (e.g., with most leading zeroes) computed hash of a batch (e.g., every 100) hashes, hashes that fall below a predetermined threshold, etc. As more hashes are computed and sent, the user device's data balance allocated or awarded by AP 200 and/or controller 350 to access a network (e.g., the Internet) may increase. For example, for every 100 hashes computed by a smartphone, the smartphone may be awarded 1 megabyte of data to access the Internet. In some implementations, the user device may compute and send hashes until the data balance achieves a certain buffer size (e.g., x megabytes). Thereafter, the user device may pause hashing. Alternatively, the user device may continue hashing throughout the time that it is connected to AP 200 without a buffer.

At operation 740, the user device accesses a computer network (e.g., Internet) through the AP using data awarded (e.g., by the AP or a controller connected to the AP) in response to performing the blockchain mining task.

Although method 700 was described in the context of the user device 100 periodically polling a networked device to retrieve information such as a blockchain mining task, a balance of data available to access the network, and a hash rate per bytes, in alternative implementations this information may be periodically pushed from the networked device to the user device 100. As such, it should be appreciated that updates may be pulled and/or pushed using an application installed on the user device and/or the OS of the user device.

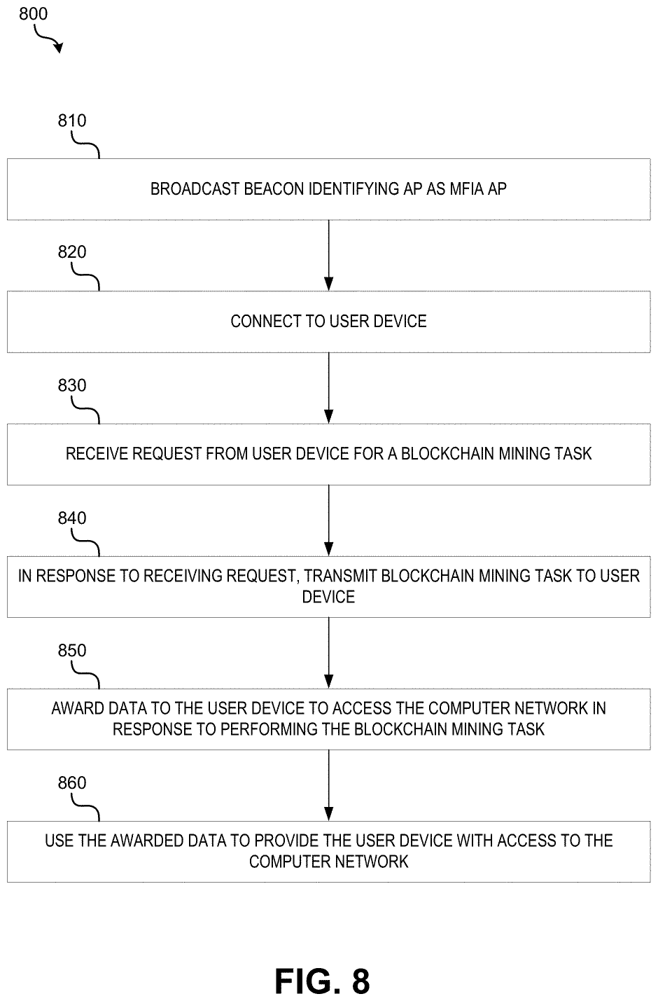

FIG. 8 is an operational flow diagram illustrating an example method 800 that may be implemented by a wireless network access system (e.g., system including an AP, an AP and controller, or an AP and some other configuration to connect user devices to a network) including an AP 200 to connect the AP 200 to a user device 100 and provide network access in exchange for blockchain mining, in accordance with implementations of the disclosure. In some implementations, some or all of the operations of method 800 may be implemented by a processing device 220 executing one or more of instructions 211-213. In some implementations, one or more of the operations of method 800 may be performed in concert with a controller and/or server that may track blockchain mining tasks to be performed by user devices accessing APs, a remaining data balance of a user device, and other data.

At operation 810, an AP of a wireless network access system broadcasts a beacon identifying the AP as an AP that provides Internet access in exchange for blockchain mining. For example, the AP may broadcast a beacon comprising a bit that provides an indication that the AP provides Internet access in exchange for blockchain mining. In particular implementations, the bit providing the indication may be specified as part of the 802.11 specification, or it may be specified in a vendor-specific field.

At operation 820, the AP connects to the user device. In implementations where the user device's OS does not natively support blockchain mining in exchange for Internet access, the wireless network access system may redirect the user device to a captive portal that directs the user to download an application (e.g., app 115) for blockchain mining in exchange for Internet access. In such implementations, once the user device initializes the app and performs a handshake with the wireless network access system to initiate mining for Internet access, the captive portal may be removed, and follow-up information such as the user device's remaining data balance may be provided via notifications in the running app.

At operation 830, the wireless network access system receives a request from the user device for a blockchain mining task. In response to the request, at operation 840 the wireless network access system transmits a blockchain mining task (e.g., values to hash and hashing technique) to the user device. In some implementations, the wireless network access system may also transmit a remaining data balance for the user device to access the network. In implementations involving blockchain mining based on hashing, a hash rate in bytes may also be transmitted to the user device.

At operation 850, the wireless network access system awards/allocates data to the user device to access the computer network (e.g., Internet) in response to the user device performing the blockchain mining task. For example, as the user device sends hashes as a part of a proof-of-work algorithm, or stores data as part of a proof-of-space algorithm, the wireless network access system may award data for the user device to access the Internet. At operation 860, the wireless network access system may use the awarded data to provide the user device with access to the computer network (e.g., Internet) as the user device attempts to access the network through the AP. It should be appreciated that operations 830-860 may be iteratively be repeated over time to provide the user device with access to the Internet in exchange for blockchain mining.

Although method 800 was described in the context of the wireless network access system being polled by user device 100 to retrieve information such as a blockchain mining task, a balance of data available to access the network, and other data (e.g., a hash rate per bytes), in alternative implementations this information may be periodically pushed from the wireless network access system to the user device 100.

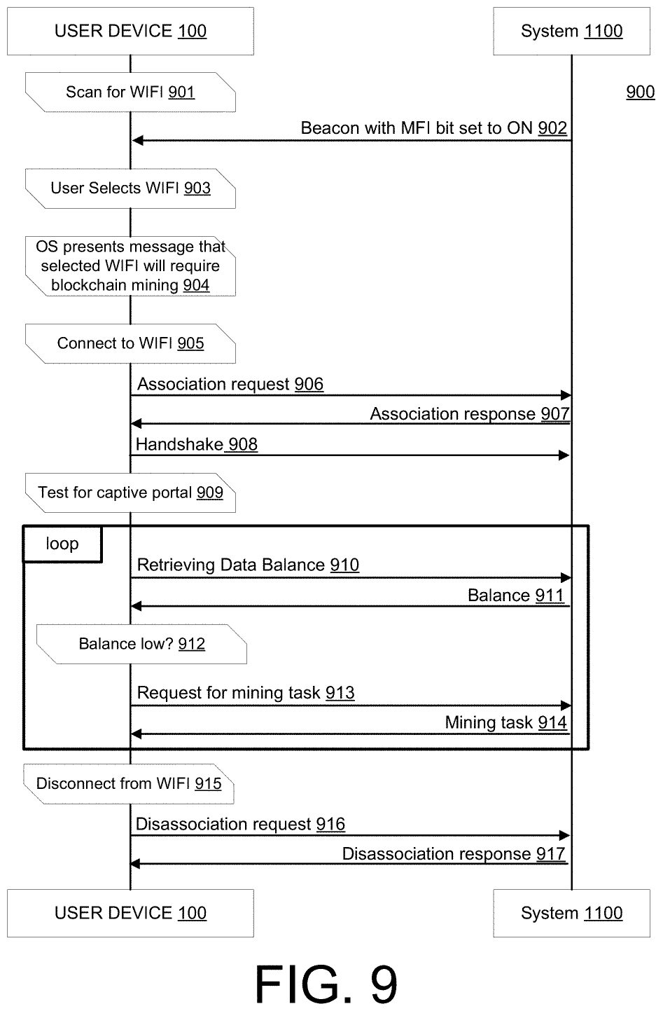

FIG. 9 is a sequence diagram illustrating a particular example method 900 that may be implemented in the environment of FIG. 1 for using a wireless network access system 1100 (e.g., an AP 200 and/or controller 300) to provide Internet access to a user device 100 through a WIFI connection in exchange for blockchain mining, in accordance with implementations of the disclosure. In the example of method 900, the OS of user device 100 provides native support for mining for Internet access.

As illustrated, at step 901 the user device 100 may scan for APs that provide a WIFI connection. At step 902, an AP 200 transmits a beacon including a bit indicating that mining for Internet access is enabled. At step 903, a user of user device 903 selects the WIFI corresponding to AP 200. At step 904, the OS of the user device presents a message indicating that the selected WIFI will require blockchain mining.

At step 905 the user device initiates the connection to the system 1100. During the connection process, an association request 906 is sent, an association response is received (step 907), and the OS engages in a MFIA handshake (step 908) with the system 1100. At step 909, the user device 100 may test for a captive portal. In this example, by virtue of having already performed the handshake, system 1100 may skip the step of redirecting user device 100 to the captive portal with the link to app installation. Alternatively, in other implementations a captive portal may be presented (e.g., to present terms and conditions to the user).

Thereafter, an iterative process for mining in exchange for Internet access may be performed between user device 100 and system 1100. In this example, the iterative process is implemented through the OS of user device 100. As part of that iterative process, user device 100 may query for a remaining data balance (step 910), receive back the remaining balance from system 1100 (step 911), determine if the data balance falls below a threshold (step 912), and if it does fall below that threshold, request and receive a mining task (steps 913-914) to be performed to increase the data balance.

The loop for MFIA may terminate after the user device 100 disconnects from system 1100 (step 915), at which point a disassociation request may be sent (step 916), and a disassociation response may be received (step 917).

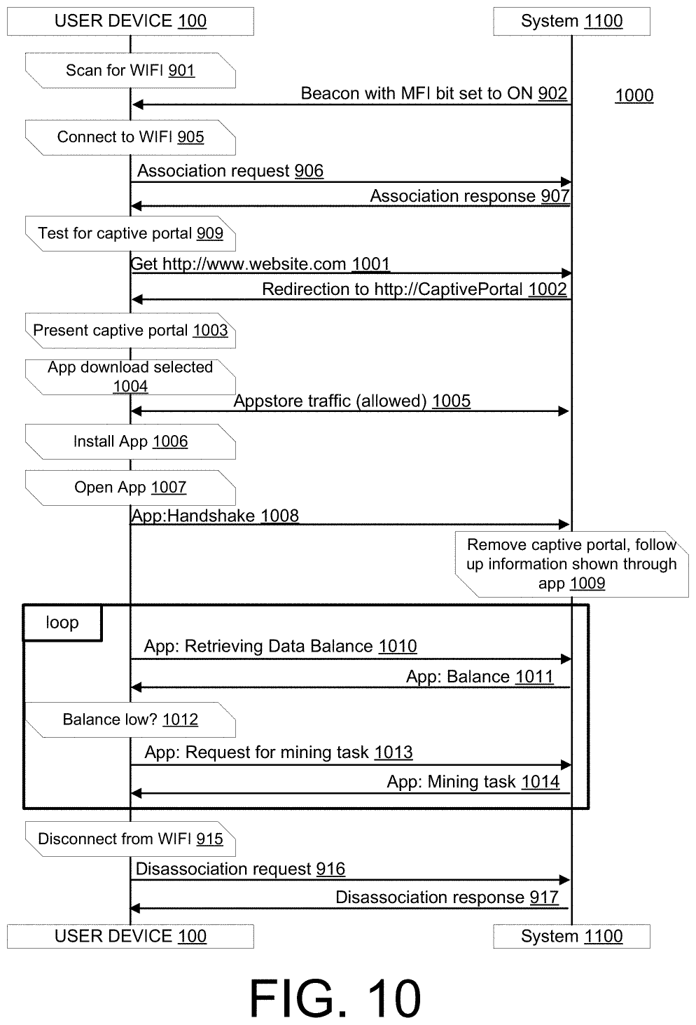

FIG. 10 is a sequence diagram illustrating another particular example method 1000 that may be implemented in the environment of FIG. 1 for using a system 1100 (e.g., an AP 200 and/or controller 300) to provide Internet access to a user device 100 in exchange for blockchain mining, in accordance with implementations of the disclosure. In the example of method 1000, the OS of user device 100 does not provide native support for mining for Internet access. For simplicity of discussion, steps 901, 902, 905-907, 909, and 915 may be performed in a manner similar to that discussed above with reference to method 900, and the discussion will not be repeated.

In this example, after the user device 100 tests for a captive portal (step 909), at step 1001 the user device 100 sends a request to system 1100 to retrieve a website. In response, the system 1100 redirects user device 100 to a Captive Portal at step 1002. At step 1003, the user device 100 presents a captive portal including an option for downloading an application that enables blockchain mining in exchange for Internet access. After the application is selected for download (step 1004), the system 1100 permits traffic to an appstore to enable the download (step 1005). Thereafter, the application is installed (step 1006), opened (step 1007), and the application engages in a handshake with system 1100 to initialize mining for Internet access (step 1008). The system 1100 removes the captive portal, and subsequent information relating to mining and Internet access may be shown through the application that was opened (step 1009). For example, the app may present notifications to the user and/or may display information when it is opened.

Thereafter, an iterative process for mining in exchange for Internet access may be performed between user device 100 and system 1100. In this example, the iterative process is implemented through the opened application. As part of that iterative process, user device 100 may query for a remaining data balance (step 1010), receive back the remaining balance from system 1100 (step 1011), determine if the data balance falls below a threshold (step 1012), and if it does fall below that threshold, request and receive a mining task (steps 1013-1014) to be performed to increase the data balance. The loop for MFIA may terminate after the user device 100 disconnects from system 1100 (step 915), at which point a disassociation request may be sent (step 916), and a disassociation response may be received (step 917).

In this document, the terms “machine readable medium,” “computer readable medium,” and similar terms are used to generally refer to non-transitory mediums, volatile or non-volatile, that store data and/or instructions that cause a machine to operate in a specific fashion. Common forms of machine readable media include, for example, a hard disk, solid state drive, magnetic tape, or any other magnetic data storage medium, an optical disc or any other optical data storage medium, any physical medium with patterns of holes, a RAM, a PROM, EPROM, a FLASH-EPROM, NVRAM, any other memory chip or cartridge, and networked versions of the same.

These and other various forms of computer readable media may be involved in carrying one or more sequences of one or more instructions to a processing device for execution. Such instructions embodied on the medium, are generally referred to as “instructions” or “code.” Instructions may be grouped in the form of computer programs or other groupings. When executed, such instructions may enable a processing device to perform features or functions of the present application as discussed herein.

In this document, a “processing device” may be implemented as a single processor that performs processing operations or a combination of specialized and/or general-purpose processors that perform processing operations. A processing device may include a CPU, GPU, APU, DSP, FPGA, ASIC, SOC, and/or other processing circuitry.

The various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. Additionally, unless the context dictates otherwise, the methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A non-transitory computer-readable medium having executable instructions stored thereon that, when executed by a processor, causes the processor to perform operations of:
transmitting a request for a blockchain mining task, the blockchain mining task comprising using a processing resource or memory resource of a user device as part of a blockchain consensus protocol for verifying one or more blockchain transactions that are written to a block of a blockchain;
in response to transmitting the request, receiving the blockchain mining task from an access point (AP);
performing the blockchain mining task by using the processing resource or memory resource of the user device; and
accessing a computer network through the AP using data awarded in response to performing the blockchain mining task.

2. The non-transitory computer-readable medium of claim 1, wherein the instructions, when executed by the processor, further cause the processor to perform operations of:
querying the AP or a controller coupled to the AP to determine a balance of data available to access the computer network;
determining if the balance of data falls below a threshold; and
if the balance of data falls below a threshold, transmitting the request for the blockchain mining task.

3. The non-transitory computer-readable medium of claim 1, wherein the instructions, when executed by the processor, further cause the processor to perform operations of:
scanning for available APs; and
in response to scanning, receiving a beacon from the AP, the beacon comprising a bit that provides an indication that the AP provides Internet access in exchange for blockchain mining.

4. The non-transitory computer-readable medium of claim 3, wherein the instructions, when executed by the processor, further cause the processor to perform operations of:
receiving data corresponding to a user selecting the AP through a user interface for selecting APs;
in response to receiving the data, presenting a message to the user indicating that accessing the selected AP will require blockchain mining.

5. The non-transitory computer-readable medium of claim 4, wherein the message comprises a warning that accessing the selected AP may deplete a user device's battery, slow down a user device, or cause a user device to run warmer.

6. The non-transitory computer-readable medium of claim 3, wherein the operations of: transmitting the request, receiving the blockchain mining task, and performing the blockchain mining task are performed using instructions embedded in an operating system of a device.

7. The non-transitory computer-readable medium of claim 3, wherein the instructions, when executed by the processor, further cause the processor to perform operations of:
displaying a captive portal, the captive portal providing a link to download an application for blockchain mining in exchange for Internet access;
downloading the application; and
initializing the application, wherein the application is to perform the operations of: transmitting the request, receiving the blockchain mining task, and performing the blockchain mining task.

8. The non-transitory computer-readable medium of claim 2, wherein the operations of querying the access point to determine the balance of data, and determining if the balance of data falls below the predetermined threshold, are iteratively repeated over time.

9. The non-transitory computer-readable medium of claim 1, wherein the AP is a WIFI AP.

10. The non-transitory computer-readable medium of claim 1, wherein the blockchain mining task comprises computing a hash of one or more values using a hashing algorithm, wherein the received blockchain mining task identifies one or more values to hash and a hashing algorithm to apply to the one or more values.

11. A method, comprising:
transmitting a request from a user device for a blockchain mining task, the blockchain mining task comprising using a processing resource or memory resource of the user device as part of a blockchain consensus protocol for verifying one or more blockchain transactions that are written to a block of a blockchain;
in response to transmitting the request, the user device receiving the blockchain mining task from a wireless access point (AP);
performing the blockchain mining task at the user device by using the processing resource or memory resource of the user device; and
accessing the Internet at the user device through the wireless AP using data rewarded in response to performing the blockchain mining task.

12. The method of claim 11, further comprising:
querying the wireless AP or a controller coupled to the wireless AP to determine a balance of data available to access the Internet;
determining if the balance of data falls below a threshold; and
if the balance of data falls below a threshold, transmitting the request to the wireless AP or the controller for the blockchain mining task.

13. The method of claim 12, further comprising:
scanning for available wireless APs using the user device; and
in response to scanning, the user device receiving a beacon from the wireless AP, the beacon comprising a bit that provides an indication that the wireless AP provides Internet access in exchange for blockchain mining.

14. The method of claim 13, further comprising:
receiving data at the user device corresponding to a user selecting the wireless AP through a user interface for selecting wireless APs;
in response to receiving the data, the user device presenting a message to the user indicating that accessing the selected wireless AP will require blockchain mining.

15. The method of claim 13, wherein the operations of: transmitting the request, receiving the blockchain mining task, and performing the blockchain mining task are performed using instructions embedded in an operating system of the user device.

16. The method of claim 13, further comprising:
displaying a captive portal on a display of the user device, the captive portal providing a link to download an application for blockchain mining in exchange for Internet access;
downloading and installing the application at the user device; and
initializing the application at the user device, wherein the application is to perform the operations of: transmitting the request, receiving the blockchain mining task, and performing the blockchain mining task.

17. A system, comprising:
a processor; and
a non-transitory computer-readable medium having executable instructions stored thereon that, when executed by the processor, cause the system to perform operations of:
transmitting a blockchain mining task to a user device, the blockchain mining task comprising using a processing resource or memory resource of the user device as part of a blockchain consensus protocol for verifying one or more blockchain transactions that are written to a block of a blockchain;
awarding data to the user device to access a computer network in response to performing the blockchain mining task; and
using the awarded data to provide the computing device with access to the computer network.

18. The system of claim 17, further comprising: a wireless access point, wherein the instructions, when executed by the processor, cause the system to perform an operation of: causing the wireless access point to broadcast a beacon identifying the access point as a device that provides Internet access in exchange for blockchain mining.

19. The system, of claim 18, wherein the instructions, when executed by the processor, further cause the system to perform an operation of: causing the AP to redirect the user device to a captive portal that directs the user to download an application for blockchain mining in exchange for Internet access.

20. The system, of claim 18, wherein the instructions, when executed by the processor, further cause the processor to perform operations of: receiving a request from the user device to transmit the blockchain mining task.
